(19) United States
(12) Patent Application Publication
(10) Pub. No.: US 2018/0184119 A1
(43) Pub. Date: Jun. 28, 2018

(54) METHOD AND DEVICE FOR DISPLAYING A SEQUENCE OF PICTURES

(71) Applicants: Vincent Bottreau, Dijon (FR); Christel Chamaret, Cesson Sevigne Cedex (FR); Jean-Claude Chevet, Cesson Sevigne Cedex (FR)

(72) Inventors: Vincent Bottreau, Dijon (FR); Christel Chamaret, Cesson Sevigne Cedex (FR); Jean-Claude Chevet, Cesson Sevigne Cedex (FR)

(21) Appl. No.: 13/138,532

(22) PCT Filed: Feb. 26, 2010
(86) PCT No.: PCT/EP2010/052487

§ 371 Date: Jun. 25, 2012

(30) Foreign Application Priority Data
Mar. 2, 2009 (FR) 0951298

(51) Int. Cl. H04N 19/59; H04N 19/154; H04N 19/33; H04N 19/61; H04N 19/80

(52) U.S. Cl. CPC H04N 19/59; H04N 19/154; H04N 19/80; H04N 19/61; H04N 19/33

(57) ABSTRACT

A method for displaying a sequence of pictures is disclosed. The sequence of picture coded as a multilayer stream comprising a base layer representative of the pictures of the sequence at a first resolution and/or first quality and at least one enhancement layer representative of the sequence pictures at a second resolution and/or second quality. The method comprises the following steps:
decode the base layer from a random access point of the base layer and at least up to the decoding of a random access point of the enhancement layer to reconstruct pictures of the base layer,
display the reconstructed pictures of the base layer,
decode the enhancement layer from the random access point of the enhancement layer to reconstruct pictures of the enhancement layer, and
display the reconstructed pictures of the enhancement layer.

The method further comprises a processing step of the pictures of the enhancement layer before their display in such a way that the variation of the image content and/or of its quality between the picture of the base layer corresponding to the time of the random access point of the enhancement layer and the pictures of the enhancement layer is gradual.

### 1. SCOPE OF THE INVENTION

The invention relates to a method and a device for displaying a sequence of pictures. More particularly, the invention relates to a method for displaying a sequence of pictures arising in the form of a multilayer stream and a display device for displaying such a sequence of pictures.

### 2. PRIOR ART

In order to allow a user to change the program displayed on its terminal, i.e. change from the display of a first sequence of pictures to a second sequence of pictures, it is known to add in the stream representative of the second sequence of pictures of the random access points (RAP). In order to increase the rapidity of access to the second stream from the first stream representative of the first sequence of pictures, it is necessary to distribute into this second stream random access points in a close manner. Such a solution has the disadvantage of increasing the bitrate of the second stream into which these random access points are inserted.

Moreover, it is known to represent a sequence of pictures in the form of a multilayer stream comprising a base layer representative of the sequence pictures at a first resolution and/or quality, called pictures of the base layer, and at least one enhancement layer representative of the pictures of said sequence at a second resolution and/or quality, called pictures of the enhancement layer. In the particular case where the second sequence of pictures that the user wants to display on its terminal comes in the form of a multilayer stream, it is known to add random access points both in the base layer and in the enhancement layer. Generally, random access points are distributed in the base layer, either in a more frequent manner, or in a similar manner as in the enhancement layer in order to limit the increase of the multilayer stream bit rate and to accelerate the display of the second stream. For example, it is recommended to insert random access points into the base layer every 2 seconds, or even every 500 milliseconds in the case where a rapid access is required, whereas random access points can be inserted into the enhancement layer on average at least every 5 seconds.

When the user indicates to the terminal that it wants to display the second sequence of pictures, the terminal waits for the arrival of a random access point of the second sequence of pictures. A terminal generally comprises a decoding device linked to a display device (e.g. a Set-Top-Box (STB) linked to a SDTV or HDTV screen). In the case where the base layer comprises more frequent random access points than the enhancement layer, the terminal therefore decodes the data of the base layer until the arrival and decoding of a random access point of the enhancement layer. From the data thus decoded, the decoding device reconstructs the corresponding pictures of the base layer. These are then displayed on the display device. After the decoding of the random access point of the enhancement layer, the terminal decodes the enhancement layer to reconstruct the pictures of the enhancement layer. These are then displayed on the display device.

Such a display is, however, unsatisfactory from a visual point of view since, at the moment when the random access point of the enhancement layer is decoded, the terminal changes from the display of the pictures of the base layer to the pictures of the enhancement layer, which can correspond to a sudden jump in terms of quality and/or content.

### 3. SUMMARY OF THE INVENTION

The purpose of the invention is to compensate for at least one disadvantage of the prior art.

For this purpose, the invention relates to a method to display a sequence of pictures coming in the form of a multilayer stream comprising a base layer representative of the pictures of the sequence at a first resolution and/or first quality, called pictures of the base layer, and at least one enhancement layer representative of the pictures of the sequence at a second resolution and/or second quality, called pictures of the enhancement layer. The base and enhancement layers comprise random access points. The method comprises the following steps:
decoding the base layer from a random access point of the base layer and at least up to the decoding of a random access point of the enhancement layer to reconstruct pictures of the base layer,
displaying the reconstructed pictures of the base layer,
decoding the enhancement layer from the random access point of the enhancement layer to reconstruct pictures of the enhancement layer,
displaying the reconstructed pictures of the enhancement layer.
   Advantageously, the method further comprises a processing step of the pictures of the enhancement layer before their display in such a manner that the variation of the picture content and/or of its quality between the picture of the base layer corresponding to the time of the random access point of the enhancement layer and the pictures of the enhancement layer is gradual.

According to a particular embodiment, the processing step is a filtering step of each of the pictures of the enhancement layer at an intermediate resolution and/or quality gradually increasing over a predefined time interval from the first resolution and/or first quality to the second resolution and/or second quality.

According to a particular characteristic, the filtering step is a sub-sampling step.

According to another particular embodiment, the processing step is a reframing step of each of the pictures of the enhancement layer by a cropping window, the size of which gradually increases over a predefined time interval between the size of a cropping window associated with the pictures of the base layer and the size of the pictures of the enhancement layer.

According to a particular characteristic, the processing step further comprises a sub-sampling step.

The invention also relates to a method for displaying a sequence of pictures coming in the form of a multilayer stream comprising a base layer representative of the pictures of the sequence at a first resolution and/or first quality, called pictures of the base layer, and at least one enhancement layer representative of the pictures of the sequence at a second resolution and/or second quality, called pictures of the enhancement layer, the base and enhancement layers comprising random access points. The device comprises:
a decoding module for decoding the base layer from a random access point of the base layer and at least up to the decoding of a random access point of the enhancement layer to reconstruct pictures of the base layer and for decoding the enhancement layer from the random access point of the enhancement layer to reconstruct pictures of the enhancement layer, and
a display module for displaying the reconstructed pictures of the base layer and of the enhancement layer.
   Advantageously, the device further comprises a processing module for processing the pictures of the enhancement layer before their display by the display module in such a manner that the variation of the picture content and/or of its quality between the picture of the base layer corresponding to the time of the random access point of the enhancement layer and the pictures of the enhancement layer is gradual.

### 4. LIST OF FIGURES

The invention will be better understood and illustrated by means of non-restrictive embodiments and advantageous implementations, with reference to the accompanying drawings, wherein:

FIG. 1 shows a picture of an enhancement layer and a picture of a base layer of a multilayer stream as well as a cropping window,

FIG. 2 shows the block diagram of the display method according to a first embodiment of the invention

FIG. 3 illustrates the display method according to a first embodiment of the invention,

FIG. 4 shows the block diagram of the display method according to a second embodiment of the invention,

FIG. 5 illustrates the display method according to a second embodiment of the invention,

FIG. 6 shows the block diagram of the display method according to a third embodiment of the invention,

FIG. 7 shows the block diagram of the display method according to a fourth embodiment of the invention,

FIG. 8 illustrates a method to change the sequence of pictures using the display method according to the invention,

FIG. 9 shows the block diagram of a method for changing the sequence of pictures using the display method according to the invention, and

FIG. 10 shows a display device according to the invention.

### 5. DETAILED DESCRIPTION OF THE INVENTION

The invention relates to a method to display a multilayer stream representative of a sequence of pictures comprising at least two layers. According to the invention, the various layers of the multilayer stream can be fully coded independently from each other. The multilayer stream can be a scalable stream comprising a base layer representative of the pictures of the sequence at a first resolution and/or quality, called pictures of the base layer, and at least one enhancement layer representative of the pictures of the sequence at a second resolution and/or quality, called pictures of the enhancement layer. However, the invention is not limited in any way to this configuration and the “multilayer stream” term is to be understood in the widest sense. It also includes the simulcast streams and the multi-view streams.

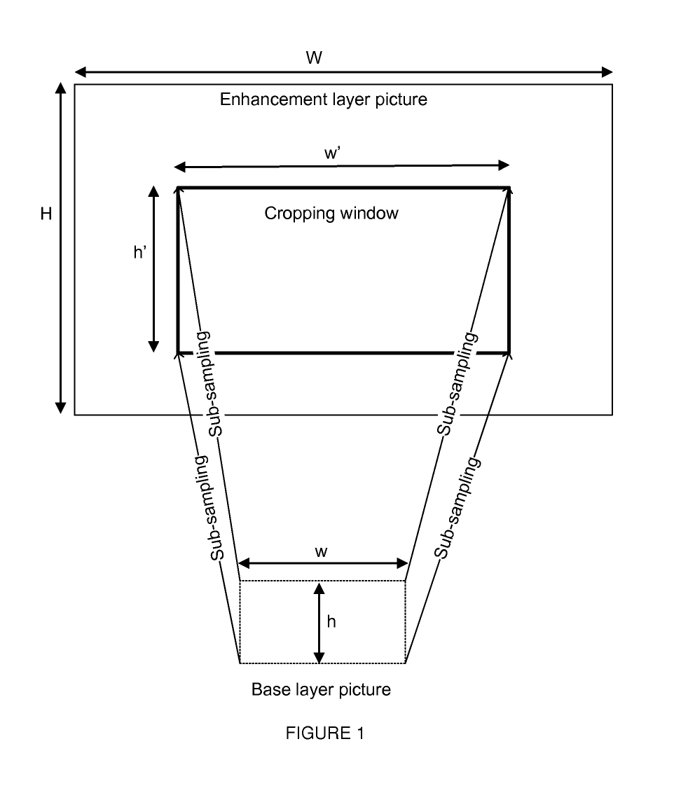

A scalable stream is for example a stream complying with the SVC video coding standard described in the JVT-AC205 document published in October 2008 and entitled Joint Draft ITU-T Rec. H.264/ISO/IEC 14496-10/Amd.3 Scalable video coding. However, the invention is not limited in any way to this standard and can be used with any multilayer stream to improve the visual comfort of the user during the display of a sequence of pictures, particularly when changing from the display of the pictures of the base layer to the pictures of the enhancement layer. The pictures of the base layer have a size (w,h), where w is the width and h the height and the pictures of the enhancement layer have a size (W,H), where W is the width and H the height. The picture content of the pictures of the base layer can be identical to the pictures of the enhancement layer even if they have a lower resolution. This is the case when the pictures of the base layer are generated by sub-sampling of the pictures of the enhancement layer. However, the picture contents can be different as illustrated in FIG. 1. This is the case in particular when the pictures of the base layer are generated by reframing then possibly sub-sampling of the pictures of the enhancement layer. In this case, the picture content of the pictures of the base layer corresponds to the picture content of only a part of the corresponding pictures of the enhancement layer. This part is delimited by a cropping window of size (w′,h′), where w′ is the width of the cropping window and h′ its height.

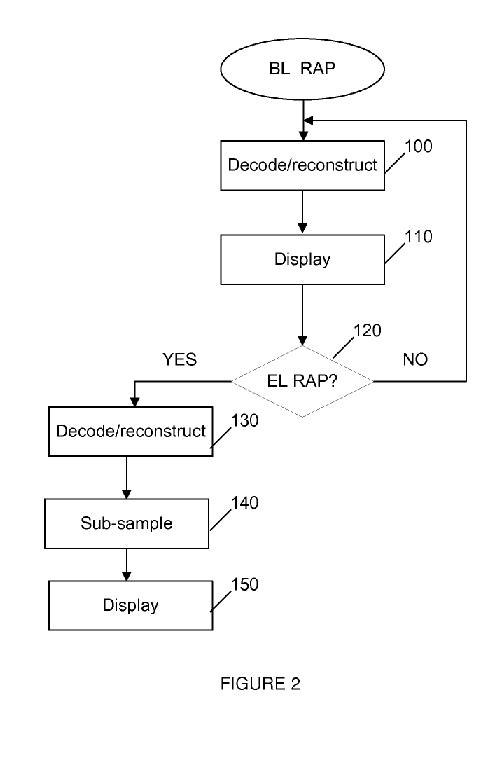

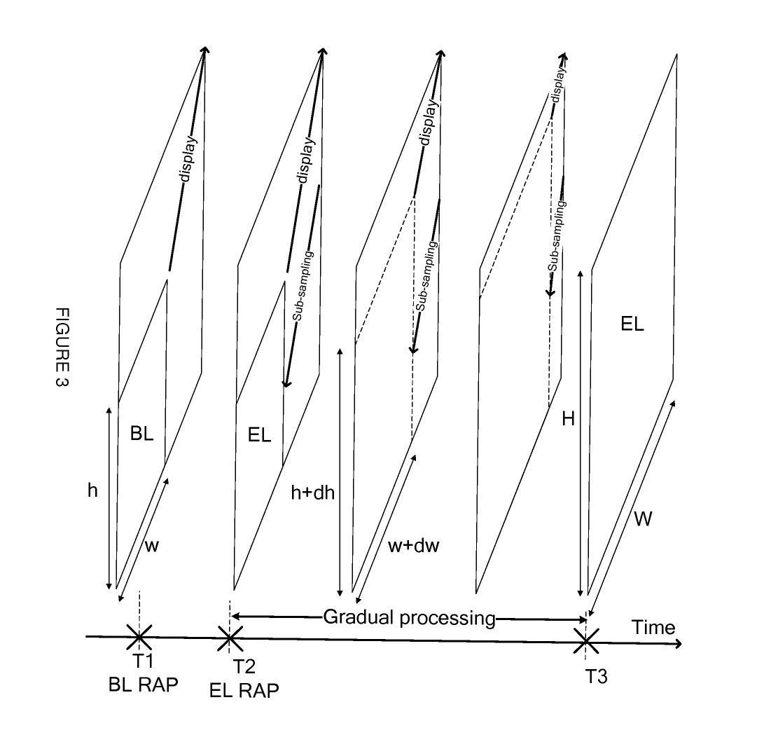

According to a first embodiment described with reference to FIGS. 2 and 3.

At step 100, the base layer is decoded from one of its random access points (corresponding to time T1 in FIG. 2) and at least up to the decoding of a random access point of the enhancement layer (corresponding to time T2 in FIG. 2) to reconstruct pictures of the base layer. If the multilayer stream complies with the SVC standard, then the pictures of the base layer are reconstructed according to the H.264/MPEG-4 AVC decoding method described in the JVT-AC205 document entitled ITU-T Rec. H.264/ISO/IEC 14496-10/Amd.3 Scalable video coding.
At step 110, the reconstructed pictures of the base layer are displayed. This step can require a spatial filtering of the pictures of the base layer to put them at the resolution of the display device. This is particularly the case if the pictures of the base layer are in the 720p format and must be displayed on a screen in the 1080p high definition (HD) format. In this particular case, the pictures of the base layer are up-sampled before display.
At step 120, if a random access point of the enhancement layer is decoded, then the method continues at step 130 otherwise it resumes at step 100.
At step 130, the enhancement layer is decoded from the random access point (corresponding to time T2 in FIG. 2) to reconstruct pictures of the enhancement layer. If the multilayer stream is a scalable stream complying with the SVC standard, then the pictures of the enhancement layer are reconstructed according to the SVC decoding method described in annex G of the JVT-AC205 document entitled Joint Draft ITU-T Rec. H.264/ISO/IEC 14496-10/Amd.3 Scalable video coding.
At step 140, the reconstructed pictures of the enhancement layer are processed. They are gradually sub-sampled over a predefined period of time, e.g. 500 ms. In FIG. 2, the gradual processing is performed between time T2 and time T3. Time T2 corresponds to the decoding of a first random access point of the enhancement layer. Time T3 can correspond to the decoding of another random access point of the enhancement layer but can also not correspond to such a random access point. Time T3 defines with respect to T2 the processing time of the pictures of the enhancement layer and therefore the duration of a gradual transition time between the display of the pictures of the base layer before or possibly at time T2 and the pictures of the enhancement layer after or possibly at time T3. This step 140 allows the display to take place gradually between the picture of the base layer at or before time T2 of the enhancement layer random access point and the pictures of the enhancement layer at or after time T3. Thus, the first enhancement picture reconstructed at time T2 is sub-sampled at the size (w,h) of the pictures of the base layer. The following picture of the enhancement layer is sub-sampled at the size (w+dw,h+dh), i.e. at a size slightly higher than that of the pictures of the base layer. For this purpose, a Lanczos poly-phase filter can be used, e.g. with 16 phases. The method is repeated on each reconstructed picture of the enhancement layer by increasing the picture size each time after sub-sampling until reaching the size (H, W) of the pictures of the enhancement layer. At each new picture of the enhancement layer, the sub-sampled picture size can be increased by dh pixels in height and dw pixels in width, e.g. dh=4 and dw=4. Thus, the quality of the pictures displayed between the pictures of the base layer and the pictures of the enhancement layer gradually increases over a period of time between T2 and T3 instead of suddenly changing if one directly changes at time T2 from the display of the pictures of the base layer to the display of the pictures of the enhancement layer.
At step 150, the processed pictures of the enhancement layer are displayed. This step can require a spatial filtering of the processed pictures of the enhancement layer to put them at the resolution of the display device. This is particularly the case if the processed pictures of the enhancement layer have a resolution lower than that of the screen on which they must be displayed. In this particular case, the processed pictures of the enhancement layer, i.e. after sub-sampling, are up-sampled before their display.
This embodiment is preferentially used when the picture content of the pictures of the base layer and of the enhancement layer is identical, i.e. when no reframing tool is used to generate the pictures of the base layer from the pictures of the enhancement layer as illustrated in FIG. 1.

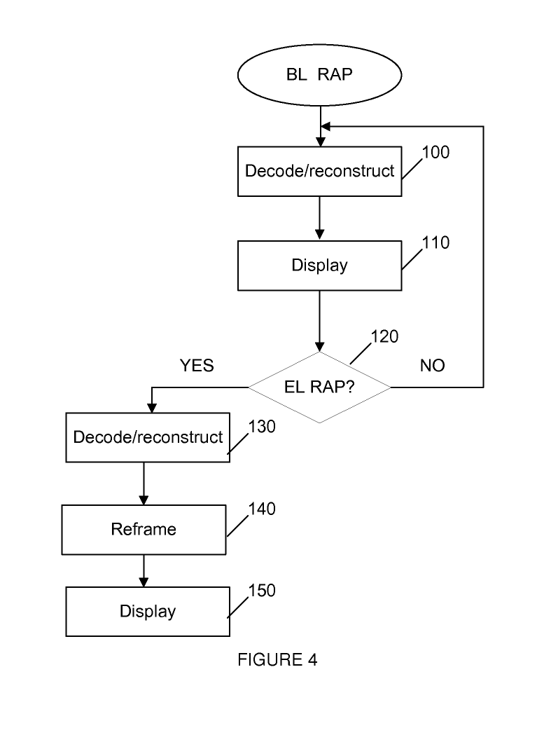

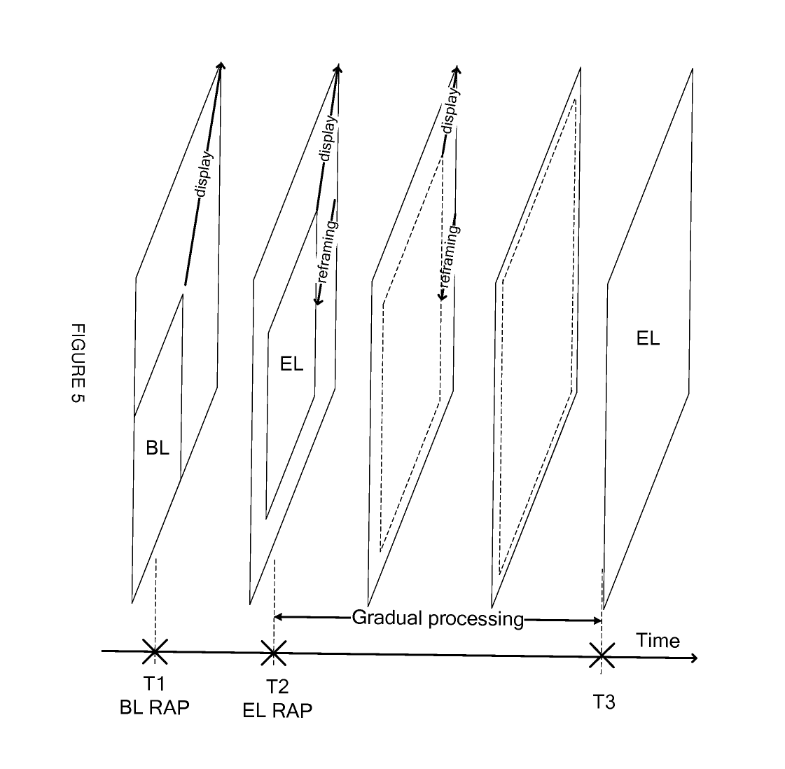

According to a second embodiment described with reference to FIGS. 4 and 5,

At step 100, the base layer is decoded from one of its random access points (corresponding to time T1 in FIG. 2) and at least up to the decoding of a random access point of the enhancement layer (corresponding to time T2 in FIG. 2) to reconstruct pictures of the base layer.
At step 110, the reconstructed pictures of the base layer are displayed. This step can require a spatial filtering of the pictures of the base layer to put them at the resolution of the display device. This is particularly the case if the pictures of the base layer are in the 720p format and must be displayed on a screen in the 1080p high definition (HD) format. In this particular case, the pictures of the base layer are up-sampled before display.
At step 120, if a random access point of the enhancement layer is decoded, then the method continues at step 130 otherwise it resumes at step 100.
At step 130, the enhancement layer is decoded from the random access point (corresponding to time T2 in FIG. 2) to reconstruct pictures of the enhancement layer.
At step 140, the reconstructed pictures of the enhancement layer are processed. They are gradually reframed over a predefined period of time, e.g. 500 ms. In FIG. 2, the gradual processing is performed between time T2 and time T3. Time T2 corresponds to the decoding of a first random access point of the enhancement layer. Time T3 can correspond to the decoding of another random access point of the enhancement layer but can also not correspond to such a random access point. Time T3 defines with respect to T2 the processing time of the pictures of the enhancement layer and therefore the duration of a gradual transition time between the display of the pictures of the base layer before or possibly at time T2 and the pictures of the enhancement layer after or possibly at time T3. This step 140 allows the display to take place gradually between the picture of the base layer at or before time T2 of the enhancement layer random access point and the pictures of the enhancement layer at or after time T3. Thus, the first enhancement picture reconstructed at time T2 is reframed at the size (w,h) of the pictures of the base layer. In this case, the cropping window of size (w,h) is positioned in the picture of the enhancement layer in such a way that its content is identical or at least very close to the picture content of the picture of the corresponding base layer. According to a particular embodiment, the position and the size of the cropping window associated with the picture of the enhancement layer at time T2 are decoded from the multilayer stream in which they are transmitted. This is particularly the case if the multilayer stream is a scalable stream complying with the SVC video coding standard.

The following picture of the enhancement layer is reframed at the size (w+dw,h+dh), i.e. at a size slightly higher than that of the pictures of the base layer. The method is repeated on each reconstructed picture of the enhancement layer by increasing the size of the cropping window each time until reaching the size (H, W) of the pictures of the enhancement layer. At each new picture of the enhancement layer, the cropping window size can be increased by dh pixels in height and dw pixels in width, e.g. dh=4 and dw=4. Thus, the additional picture content between the pictures of the base layer and the pictures of the enhancement layer is gradually added over a period of time between T2 and T3 instead of being suddenly added if, at time T2, there is a direct change from the display of the pictures of the base layer to the display of the pictures of the enhancement layer.

At step 150, the reframed pictures of the enhancement layer are displayed. This step can require a spatial filtering of the reframed pictures of the enhancement layer to put them at the resolution of the display device. This is particularly the case if the reframed pictures of the enhancement layer have a resolution lower than that of the screen on which they must be displayed. In this particular case, the reframed pictures of the enhancement layer are up-sampled before display.

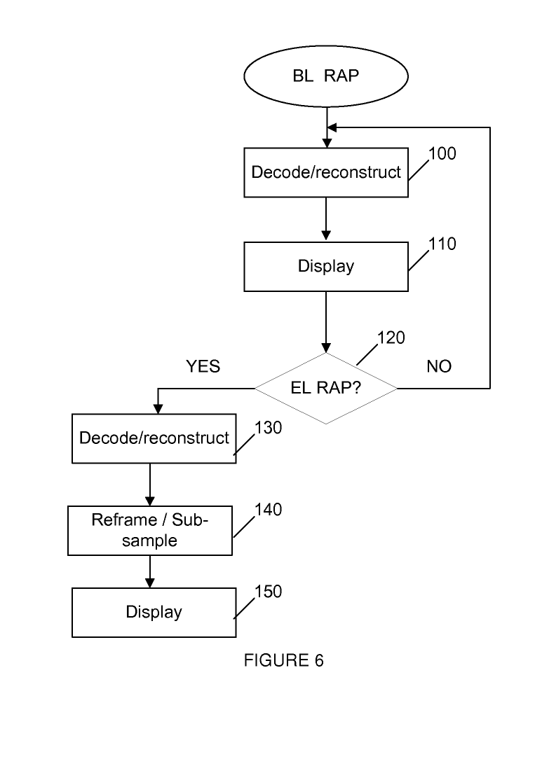

A third embodiment described with reference to FIG. 6 combines the two preceding embodiments.

At step 100, the base layer is decoded from one of its random access points (corresponding to time T1 in FIG. 2) and at least up to the decoding of a random access point of the enhancement layer (corresponding to time T2 in FIG. 2) to reconstruct pictures of the base layer.
At step 110, the reconstructed pictures of the base layer are displayed. This step can require a spatial filtering of the pictures of the base layer to put them at the resolution of the display device. This is particularly the case if the pictures of the base layer are in the 720p format and must be displayed on a screen in the 1080p high definition (HD) format. In this particular case, the pictures of the base layer are up-sampled before display.
At step 120, if a random access point of the enhancement layer is decoded, then the method continues at step 130 otherwise it resumes at step 100.
At step 130, the enhancement layer is decoded from the random access point (corresponding to time T2 in FIG. 2) to reconstruct pictures of the enhancement layer.
At step 140, the pictures of the enhancement layer are processed. They are gradually reframed and sub-sampled over a predefined period of time, e.g. 500 ms. In FIG. 2, the gradual processing is performed between time T2 and time T3. Time T2 corresponds to the decoding of a first random access point of the enhancement layer. Time T3 can correspond to the decoding of another random access point of the enhancement layer but can also not correspond to such a random access point. Time T3 defines with respect to T2 the processing time of the pictures of the enhancement layer and therefore the duration of a gradual transition time between the display of the pictures of the base layer before or possibly at time T2 and the pictures of the enhancement layer after or possibly at time T3. This step 140 allows the display to take place gradually between the picture of the base layer at or before time T2 of the enhancement layer random access point and the pictures of the enhancement layer at or after time T3. Thus, the first enhancement picture reconstructed at time T2 is reframed at the size (w′,h′) of the cropping window used to generate the pictures of the base layer according to the method illustrated by FIG. 1. In this case, the cropping window of size (w′,h′) is positioned in the picture of the enhancement layer in such a way that its content is identical or at least very close to the picture content of the corresponding base layer. According to a particular embodiment, the position and the size of the cropping window associated with the picture of the enhancement layer at time T2 are decoded from the multilayer stream in which they are transmitted. This is particularly the case if the multilayer stream is a scalable stream complying with the SVC video coding standard.
The picture of the enhancement layer reframed in this way is then sub-sampled at the size (w,h) of the picture of the base layer.
The following picture of the enhancement layer is reframed at the size (w′+dw,h′+dh) then sub-sampled at a size (w+dw, h+dh). The method is repeated on each reconstructed picture of the enhancement layer by increasing the size of the cropping window and of the sub-sampled picture each time until reaching the size (H, W) of the pictures of the enhancement layer. Thus, the additional picture content between the pictures of the base layer and the pictures of the enhancement layer is gradually added over a period of time between T2 and T3 instead of being suddenly added if, at time T2, there is a direct change from the display of the pictures of the base layer to the display of the pictures of the enhancement layer. Likewise, the quality of the pictures displayed between the pictures of the base layer and the pictures of the enhancement layer gradually increases over a period of time between T2 and T3 instead of suddenly changing if, at time T2, there is a direct change from the display of the pictures of the base layer to the display of the pictures of the enhancement layer.
At step 150, the processed pictures of the enhancement layer are displayed. This step can require a spatial filtering of the processed pictures of the enhancement layer to put them at the resolution of the display device. This is particularly the case if the processed pictures of the enhancement layer have a resolution lower than that of the screen on which they must be displayed. In this particular case, the reframed pictures of the enhancement layer are up-sampled before display.

These last two embodiments are preferentially used when the picture content of the pictures of the base layer and of the enhancement layer is different, particularly when the pictures of the base layer are generated from a part only of the pictures of the enhancement layer, said part being delimited in the pictures of the enhancement layer by a cropping window as illustrated in FIG. 2.

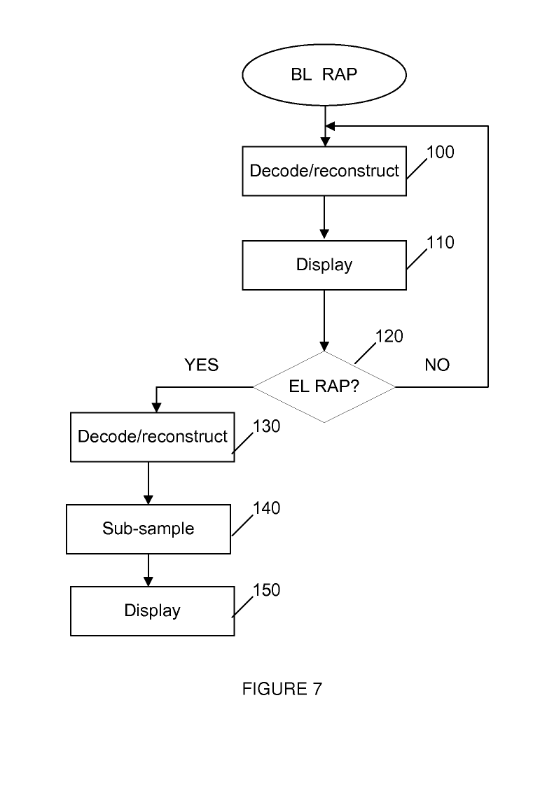

A fourth embodiment is described with reference to FIG. 7.

At step 100, the base layer is decoded from one of its random access points (corresponding to time T1 in FIG. 2) and at least up to the decoding of a random access point of the enhancement layer (corresponding to time T2 in FIG. 2) to reconstruct pictures of the base layer.
At step 110, the reconstructed pictures of the base layer are displayed. This step can require a spatial filtering of the pictures of the base layer to put them at the resolution of the display device. This is particularly the case if the pictures of the base layer are in the 720p format and must be displayed on a screen in the 1080p high definition (HD) format. In this particular case, the pictures of the base layer are up-sampled before display.
At step 120, if a random access point of the enhancement layer is decoded, then the method continues at step 130 otherwise it resumes at step 100.
At step 130, the enhancement layer is decoded from the random access point (corresponding to time T2 in FIG. 2) to reconstruct pictures of the enhancement layer.
At step 140, the pictures of the enhancement layer are processed. They are gradually filtered over a predefined period of time, e.g. 500 ms. In FIG. 2, the gradual processing is performed between time T2 and time T3. Time T2 corresponds to the decoding of a first random access point of the enhancement layer. Time T3 can correspond to the decoding of another random access point of the enhancement layer but can also not correspond to such a random access point. Time T3 defines with respect to T2 the processing time of the pictures of the enhancement layer and therefore the duration of a gradual transition time between the display of the pictures of the base layer before or possibly at time T2 and the pictures of the enhancement layer after or possibly at time T3. This step 140 allows the display to take place gradually between the picture of the base layer at or before time T2 of the enhancement layer random access point and the pictures of the enhancement layer at or after time T3. Thus, the first enhancement picture reconstructed at time T2 is filtered so as to obtain a quality close to that of the picture of the base layer. This filtering can be performed by sub-sampling at an arbitrary lower resolution (w″,h″) followed by up-sampling at the resolution (W,H).
The following picture of the enhancement layer is filtered so as to obtain an intermediate quality between that of the picture of the base layer and that of the picture of the enhancement layer. This filtering can be performed by sub-sampling at a lower resolution (w″+dw″,h″+dw″) followed by up-sampling at the resolution (W,H). The method is repeated on each picture of the enhancement layer reconstructed by increasing the quality of the filtered picture each time until reaching the quality of the pictures of the enhancement layer. Thus, the picture quality between the pictures of the base layer and the pictures of the enhancement layer is gradually improved over a period of time between T2 and T3 instead of being suddenly improved if, at time T2, there is a direct change from the display of the pictures of the base layer to the display of the pictures of the enhancement layer.

This embodiment is preferentially used when the pictures of the base layer and of the enhancement layer have the same resolution, i.e. when (w, h)=(W, H) but when the quality/fidelity of the pictures of the base layer in comparison with the pictures of the original sequence (also source sequence) is lower than that of the pictures of the enhancement layer. The gradual processing of the pictures of the enhancement layer during the transitional period between T2 and T3 is performed in such a way that the quality of the processed pictures gradually increases between the quality of the pictures of the base layer before or at time T2 and the quality of the pictures of the enhancement layer at or after time T3.

These four embodiments advantageously allow the visual comfort on display to be improved. Indeed, the transition between the display of the pictures of the base layer and the pictures of the enhancement layer is gradual in terms of content and/or quality, i.e. fidelity to the pictures of the source sequence. Note that, for these four embodiments, it is possible to display at time T2 either the picture of the corresponding base layer or a picture of the processed enhancement layer. Likewise, it is possible to display at time T3 either a picture of the processed enhancement layer or the corresponding picture of the enhancement layer.

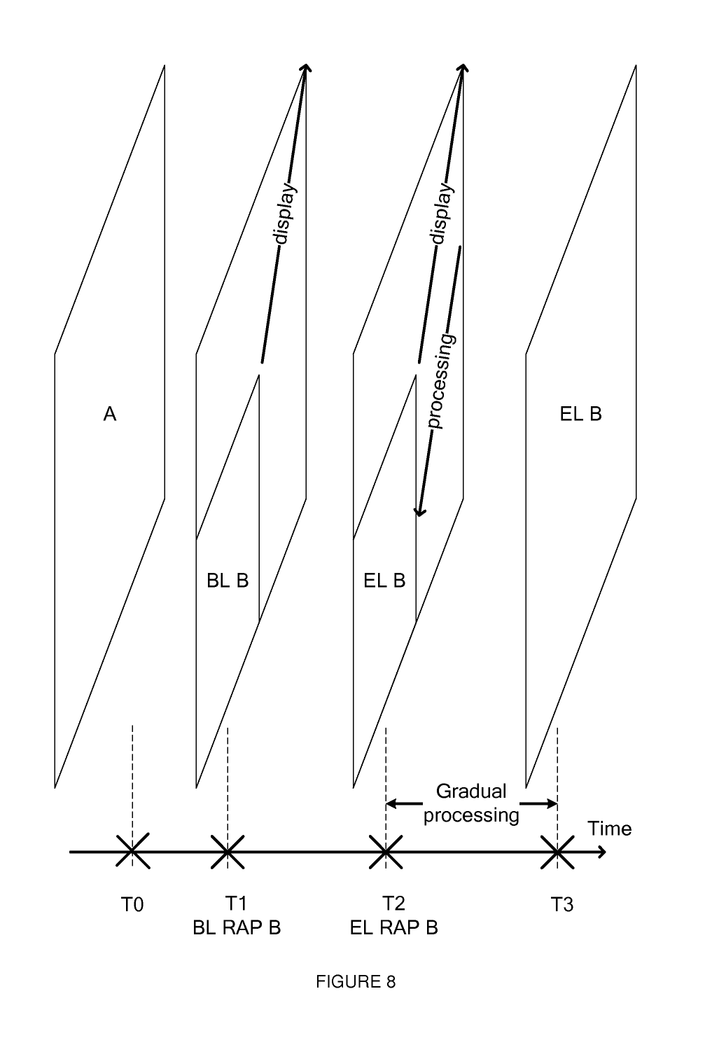

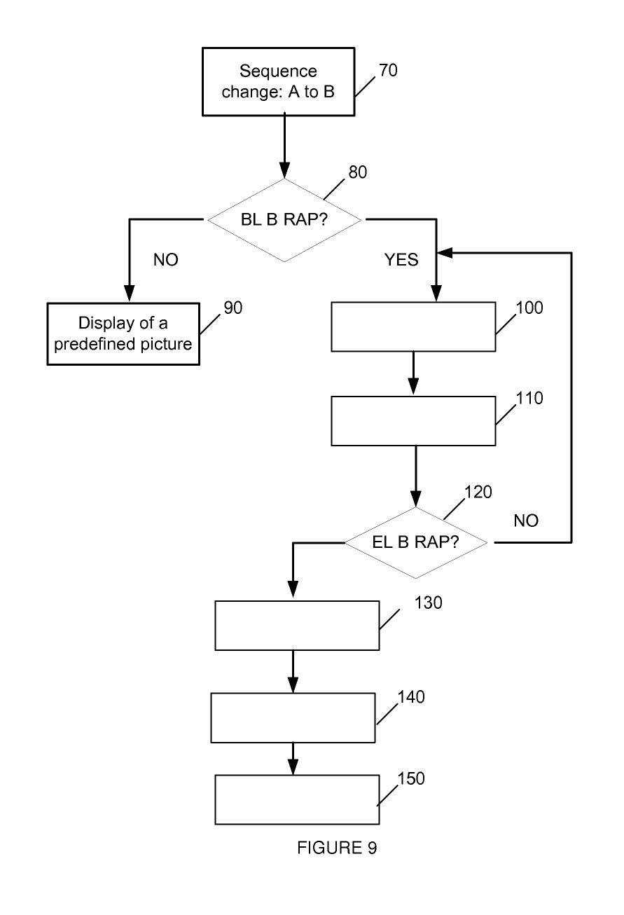

The method according to the invention is advantageously used to improve the display from a visual point of view in the case where a user wants to change from the display of a first sequence to a second sequence. Hence, with reference to FIGS. 8 and 9, a user indicates at step 70 that he wants to change from the display of the sequence of pictures A to sequence of pictures B represented in multilayer form.

At step 80, if a random access point is decoded for the base layer, then the method continues at step 100 otherwise it continues at step 90.

At step 90, a predefined picture is displayed on the screen as long as a random access point of the base layer is not decoded. Steps 100 to 150 are identical to steps 100 to 150 previously described with reference to one of the embodiments and are not further described.

The predefined picture is for example a black image or still the last picture of sequence A displayed before the receipt of a signal indicating the user's will to change sequences.

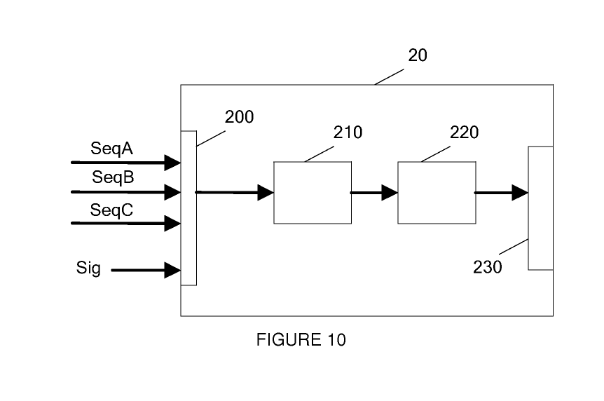

The invention also relates to a display device 20 represented in FIG. 10. The display device 20 comprises an input 200 capable of receiving sequence of pictures seq A, seq B and seq C. On this input the display device is also capable of receiving a signal sig indicating which sequence of pictures the user wants to see displayed. The display device 20 further comprises connected to the input 200 a decoding module to decode a multilayer stream to reconstruct pictures of a base layer and pictures of an enhancement layer. In particular, the decoding module 210 is adapted to implement the steps 100, 120 and 130 of the method according to one of the invention embodiments. It comprises moreover connected to the decoding module 210 a processing module 220 capable of processing the pictures of the enhancement layer before their display according to the step 140 of the method according to one of the invention embodiments. The processing module 220 is connected to a display module 230 adapted to display the pictures of the base layer on a screen of the display module 230 and the pictures of the enhancement layer. The display module 230 is adapted to spatially filter, if necessary, the pictures received from the processing module 220 in order to adapt their size to that of the screen. Generally, the display module 230 performs an up-sampling of the pictures received from the processing module 220.

1. Method for displaying a sequence of pictures coded as a multilayer stream comprising a base layer representative of the pictures of said sequence at a first resolution and/or first quality, called pictures of the base layer, and at least one enhancement layer representative of the pictures of said sequence at a second resolution and/or second quality, called pictures of the enhancement layer, said base and enhancement layers comprising random access points, said method comprising the following steps:
decoding the base layer from a random access point of the base layer and at least up to the decoding of a random access point of the enhancement layer to reconstruct pictures of the base layer,
displaying said reconstructed pictures of the base layer,
decoding the enhancement layer from said random access point of the enhancement layer to reconstruct pictures of the enhancement layer,
displaying said reconstructed pictures of the enhancement layer,
said method further comprising a reframing step for reframing, before their display, said images of the enhancement layer by a cropping window the size of which gradually increases between the size of a cropping window associated with the pictures of the base layer and the size of the pictures of the enhancement layer over a time interval the start of which is the random access point of the enhancement layer.

2. Method according to claim 1, wherein said processing step further comprises a sub-sampling step.

3. Display device of a sequence of pictures coded as a multilayer stream comprising a base layer representative of the pictures of said sequence at a first resolution and/or first quality, called pictures of the base layer, and at least one enhancement layer representative of the pictures of said sequence at a second resolution and/or second quality, called pictures of the enhancement layer, said base and enhancement layers comprising random access points, said device comprising:
a decoding module for decoding the base layer from a random access point of the base layer and at least up to the decoding of a random access point of the enhancement layer to reconstruct pictures of the base layer and for decoding the enhancement layer from said random access point of the enhancement layer to reconstruct pictures of the enhancement layer,
a display module for displaying said reconstructed pictures of the base layer and of the enhancement layer,
the device being further comprising a processing module for reframing, before their display by the display module, said images of the enhancement layer by a cropping window the size of which gradually increases between the size of a cropping window associated with the pictures of the base layer and the size of the pictures of the enhancement layer over a time interval the start of which is the random access point of the enhancement layer.
